(19) United States
(12) Patent Application Publication
(10) Pub. No.: US 2006/0036540 A1
(43) Pub. Date: Feb. 16, 2006

(54) Method and system for merchant indemnification for online financial transactions

(76) Inventors: Steve Lawrence, Nassau (BS); Gord Herman, (US)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/926,968

(22) Filed: Aug. 27, 2004

Related U.S. Application Data
(60) Provisional application No. 60/600,366, filed on Aug. 11, 2004.

(51) Int. Cl. G06Q 40/00

(52) U.S. Cl. 705/39

(57) ABSTRACT

A method and system enable indemnification of funds transferred electronically to an end merchant. An intermediary service having a server in communication with an automated clearinghouse system and having a client interface provides an online account for committing an irrevocable transfer of funds to the merchant account of a participating end merchant at the request of a client. Preferably, the intermediary verifies the client's identify and authorization to access the client's source account. In particular, the intermediary can provide an irrevocable transfer of funds to an end merchant substantially instantly upon the request of the payor client.

### CROSS REFERENCE TO RELATED APPLICATION

This application claims priority of U.S. Provisional Patent application Ser. No. 60/600,366 filed Aug. 11, 2004 to Lawrence et al., the entirety of which is incorporated herein by reference.

### FIELD OF THE INVENTION

The present invention relates broadly to methods for an intermediate third party management and indemnification of electronic fund transfers from a customer source account to end merchants and more particularly to the irrevocable electronic transfer of funds to a specified destination account in advance of the usual verification of the successful withdrawal and settlement from the customer's source account during an automated clearing house cycle.

### BACKGROUND OF THE INVENTION

Hundreds of thousands of electronic fund transfers (EFT) representing millions of dollars are processed daily through the use of credit cards, debit cards and transfers. Point of sale (POS) or face-to-face transactions include various safeguards to minimize fraud and abuse of these transactions including presentation of the actual physical instrument or card, signature verification and presentation of supplementary identification.

Financial transactions are also occurring through distributed network or online systems such as the internet. These online transactions have few or none of the assurances or ease of right-to-use verification of the POS situations. Further, some online services and merchants often use merchant accounts or intermediate financial accounts into which customers deposit funds. While withdrawals are readily permitted from most financial instruments such as in the case of payment of services, fewer are able to enable deposits from that instrument into a destination account.

Online merchants traditionally only conduct basic verifications of the payment means such as to confirm the client's zip or postal code or whether the card has been reported stolen. Online verification is readily thwarted if a credit card is stolen along with the card owner's personal information or identity.

Accordingly, in this higher risk environment, third party intermediaries are now providing online accounts and online verification services for verifying the purported owner's right of access to a payment means and enabling EFT to the merchant. Also, in many instances, the client may themselves desire to use an intermediary between themselves and the vendor so as to shield sensitive financial and personal information from the recipient often in what is an isolated transaction with a vendor of unknown repute. Typically, a client makes a payment to the intermediary, who then funds an online, intermediary account. While withdrawals are readily permitted from most financial instruments such as credit cards, fewer are able to enable payments to an intermediary account. Therefore, it is usual to perform an EFT from a client's account.

There are still risks to the merchant. First, the merchant is accepting a third party's verification of the fund transfer. Ultimately, if there is a chargeback to the third party intermediary's online account for a customer (such as a disputed authorization), then typically, the value of the chargeback is deducted from the funds settlement forwarded periodically to the merchants.

The risk is further intensified in situations where the desire for substantially instantaneous access to funds is desired. Typically, an EFT requires upwards of 4 days to clear an applicable automated clearinghouse (ACH System). ACH-qualifying receiving account and client account information is provided. The settlement date for payment is delayed so that the account details and sufficient funds in the client's account can be confirmed. Thus in some time-sensitive financial transactions, the client may be precluded or prejudiced from participating in a financial opportunity due to the time lag between making an offer and the ACH settlement process.

Despite the risk, should a merchant nevertheless make an advance of a good or service or monetary disbursement to or on behalf of a customer on a mere confirmation that the EFT has been initiated, a subsequent rejection of the EFT or a charge-back can leave the merchant in a loss position.

Accordingly, there exists a need for an arrangement and method for managing the transfer of funds to merchants which better protects merchants and provides assurances that advancing or remuneration for services is substantially irrevocable.

### SUMMARY OF THE INVENTION

A method and system enable indemnification of funds transferred electronically to an end merchant. An end merchant can now commit the transferred funds without concern of a dishonoured transfer or a charge-back. While some losses through charge-backs are normally expected in usual commercial trade, risk is increased through online electronic transactions and as the turnaround shortens between pledging of the advancement of funds and the normal settlement cycle of electronic automated clearinghouse systems.

While intermediaries may exist between a payor and the payee for culling the highest risk debtors, ultimately the end merchant could face a loss on a charge-back such as a legitimate refund of a transfer of funds due to a fraudulent transaction out of the control of both a legitimate payor and the intermediary.

Both a payor and an end merchant benefit from a system which indemnifies an end merchant, encouraging providing of goods and services to a requesting payor, and encouraging timely commitment by a payor to access the end merchant's goods and services.

Accordingly in one aspect, an intermediary service provides an online account for committing an irrevocable transfer of funds to the merchant account of a participating end merchant at the request of a client. Preferably, the intermediary verifies the client's identify and authorization to access a source account of the client. In particular, the intermediary can provide an irrevocable transfer of funds to an end merchant substantially instantly upon the request of the payor client.

Accordingly, a method is provided for making an irrevocable advance of funds to an end merchant by a requesting client without waiting for a successful settlement of an electronic fund transfer from the requesting client, comprises providing an intermediary service having a server system in electronic communication with the client, the end merchant, and an intermediate account; receiving at the intermediary service an request from the requesting client to transfer an amount of requested funds to the end merchant from a source account; irrevocably committing at least a permitted amount of the requested amount of the requested funds by initiating an first electronic fund transfer from the intermediate account as transferred funds which are transferred to the end merchant; and thereafter, initiating a settlement transaction including submitting a second electronic fund transfer for seeking to recover at least the permitted amount of the requested funds from the source account to the intermediary account.

In another aspect, a system is provided for making an irrevocable advance of funds to an end merchant by a requesting client without waiting for a successful settlement of an electronic fund transfer from the requesting client, the system comprising: an intermediary service having a server in electronic communication with the client, the end merchant, and an intermediate account; a client interface for receiving at the intermediary service an request from the requesting client to transfer an amount of requested funds to the end merchant from a source account; a verification interface for obtaining from the requesting client an assertion of the requesting client's authorization to transfer funds from the source account and limiting a permitted amount of the requested funds to be transferred based on the strength of the client's assertion; a first automated clearinghouse request means for committing transfer of the permitted amount of the requested funds from the intermediate account as transferred funds which are transferred to the end merchant, the transferred funds being irrevocable to the end merchant; and a second automated clearinghouse request means for initiating a settlement transaction including transfer of at least the permitted amount of the requested funds from the source account to the intermediary account.

### BRIEF DESCRIPTION OF THE DRAWINGS

FIG. 1 is a block diagram illustrating one embodiment of a system and methodology for an irrevocable advance from a client to an end merchant; and

FIGS. 2A-2D are a continuum of block diagrams illustrating an embodiment of conventional and expedited transfer of funds to an end merchant from an intermediate online account as initiated by a client.

### DETAILED DESCRIPTION OF A PREFERRED EMBODIMENT

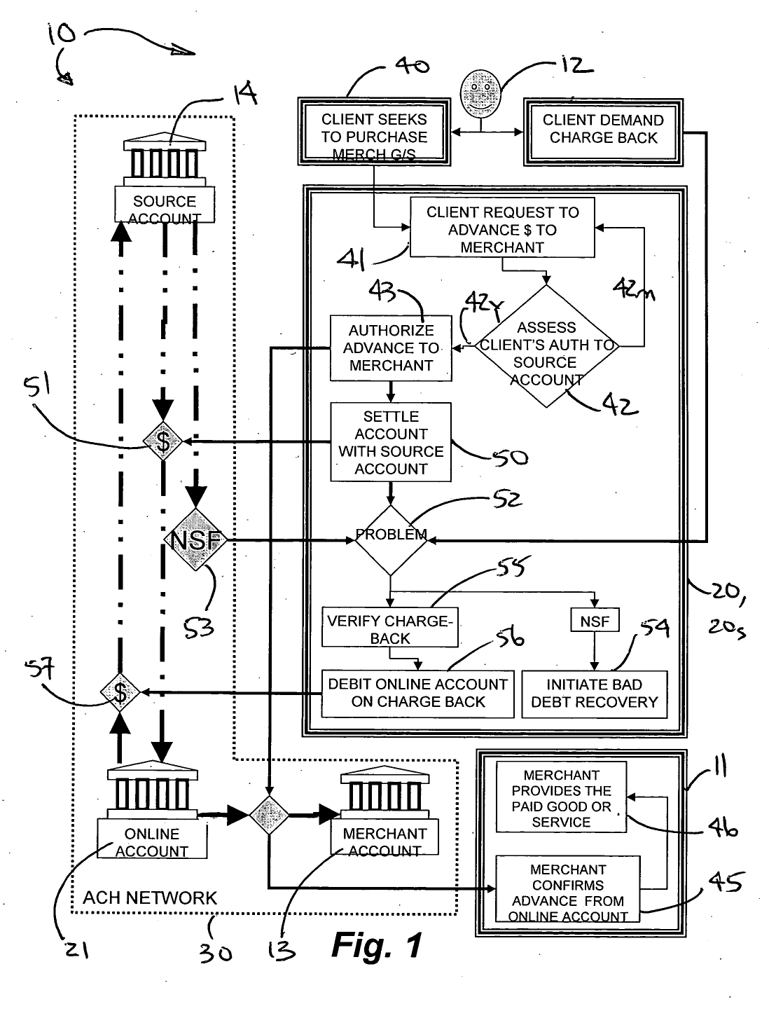

With reference to FIG. 1 and generally, in one embodiment of a methodology and system 10 implemented for the protection of financial transactions to a merchant, an online merchant seeks funds from a client for a good or a service including a disbursement made by the merchant on behalf of the client. The online merchant is the end recipient of the funds transferred thereto for satisfaction of the client's financial obligations and thus, such a merchant is termed herein an “end merchant 11”. For example, the client may be a client 12 or customer of the end merchant 11 and funds are needed to initiate or participate in the merchant's goods or services. An example is an end merchant who themselves commit a monetary amount to another or some irredeemable transaction. The end merchant 11 requires the client 12 to hold a positive balance in a merchant account 13 prior to commencing the activity. Typically, the client would fund the account from a source account 14. The usual mechanisms to fund the merchant account 13 include EFT (including online cheques) and credit cards. Herein, funding through financial institutions and credit means such as credit cards are both deemed to be from source accounts 14 of the client 12.

In the conventional systems, to satisfy the end merchant's financial demand, the client 12 requests transfer of funds and an EFT and deposit is acknowledged at the recipient merchant account 13. Settlement of an electronic fund transfer takes some time before the transaction clears the source account 14. In either case, the end result is that settlement from the client's source account 14 could fail (be dishonoured) and no funds would be ultimately be withdrawn or, even if withdrawn, initiation of a charge-back could reverse any such withdrawal or debit made from that source account 14. Thus, for the protection of consumers from fraudulent transactions, and under agreements between financial institutions and between credit card issuers and merchants, charge-backs are to be honoured by the recipient to the benefit of the consumer. Thus, whether the source account 14 has insufficient funds, there was fraudulent transaction or a fraudulent initiation of a charge-back, the recipient or end merchant 11 would have to surrender the transferred funds.

Therefore, it is the usual case to await settlement before an end merchant 11 themselves commit the funds.

As set forth in the present embodiment, end merchants 11 prefer to avoid being the recipient and subsequent relinquisher of the ill-fated funds in the aforementioned scenario.

Thus, an intermediary service 20 provides an intermediate or online account 21. The intermediary service 20 becomes an intermediate merchant of financial services and becomes an intermediate recipient which would bear the results of a dishonoured EFT or charge back.

Simply then, and with reference again to FIG. 1, when an end merchant 11 seeks funds from a client 12, the client 12 contacts the intermediary service 20 who then irrevocably credits funds to the end merchant's account 13 from the online account 21. The intermediary service 20 effectively indemnifies funds transferred to the end merchant 11 and then settles their own online account 21 by an EFT from the client's source account 14. The end merchant 11 typically manages a plurality of transferred funds to a plurality of destination client account ledgers of the end merchant's merchant account 13 or accounts. The client 12 can make periodic access to a whole or a part of the transferred funds expressly for purchasing the goods or services of the end merchant 11.

The intermediate service 20 therefore comprises one server 20s, or one or more servers 20s, (fancifully represented in FIG. 1 as synonymous with the intermediate service 20) in electronic communication over a distributed network such as the internet. The server 20s is in electronic communication with an automated clearinghouse system (ACH System 30) which is authorized to engage and settle electronic financial transactions. The intermediate service 20 further comprises the online account 21 which is in communication with the ACH System 30.

In the US, the Federal Reserve Banks are collectively the largest automated clearinghouse operators in the ACH System 30. There are also private-sector ACH operators processing the balance of the financial transactions. More information is available at the National Automated Clearinghouse Association (NACHA) at www.nacha.org. In Canada, an equivalent ACH system is the Automated Clearing Settlement System (ACSS) handing about 99% of the volume of transactions and the Large Value Transfer System (LVTS) which clears about 85% of the value of the transfers such as in settlements of a day's cumulative transactions. More information is available from the Canadian Payments Association at www.cdnpay.ca.

The server 20s is also in communication with a participating end merchant 11 which has the merchant account 13 in communication with the ACH system 30. A participating end merchant 11 is one who has entered into a contract with the intermediary service 20 so as to receive funds under an embodiment of the invention.

The server 20s is in communication with clients 12 of the end merchant 11. Clients 12 represent or assert to the intermediary service 20 that they have a source account 14 from which they will fund financial transactions. The client 12 provides transit, institution and account numbers representing the identification of the source account 14. Such a source account 12 is in communication with the ACH System 30.

The server 20s has an interface for interacting with the client 12 for receiving a request to make an EFT, for receiving details of a source account 14 and for engaging the client in at least one level of verification of the client's right to access the source account 14. The server 20s manages clients 12 and client information for conducting the requested transfer of funds and any subsequent transactions.

The intermediary service 20 performs a risk assessment of the client's ability to pay and typically limits the maximum amount of funds which can be advanced to the end merchant 11. Due to the risks to the intermediate service 20 of a dishonoured EFT or charge-back, the intermediary service 20 typically charges a fee which, on a cumulative basis for a plurality of transactions, is statistically sufficient to exceed losses. Such a fee can be obtained as part of the settlement with the source account 14.

In summary then, the process as set forth in FIG. 1 comprises, at block 40, an arrangement between the end merchant 11 and the client 12 which requires a transfer of funds such as for the purchase of goods or services. The client 12 is referred to the intermediary server 20, by the end merchant 11 or other information source.

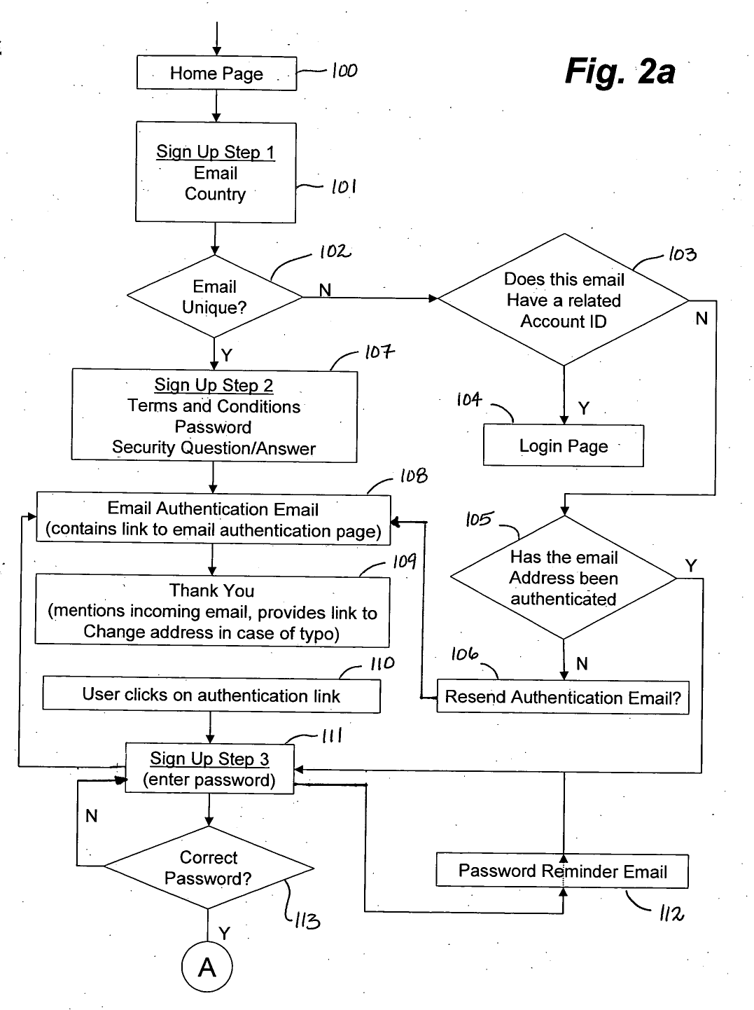

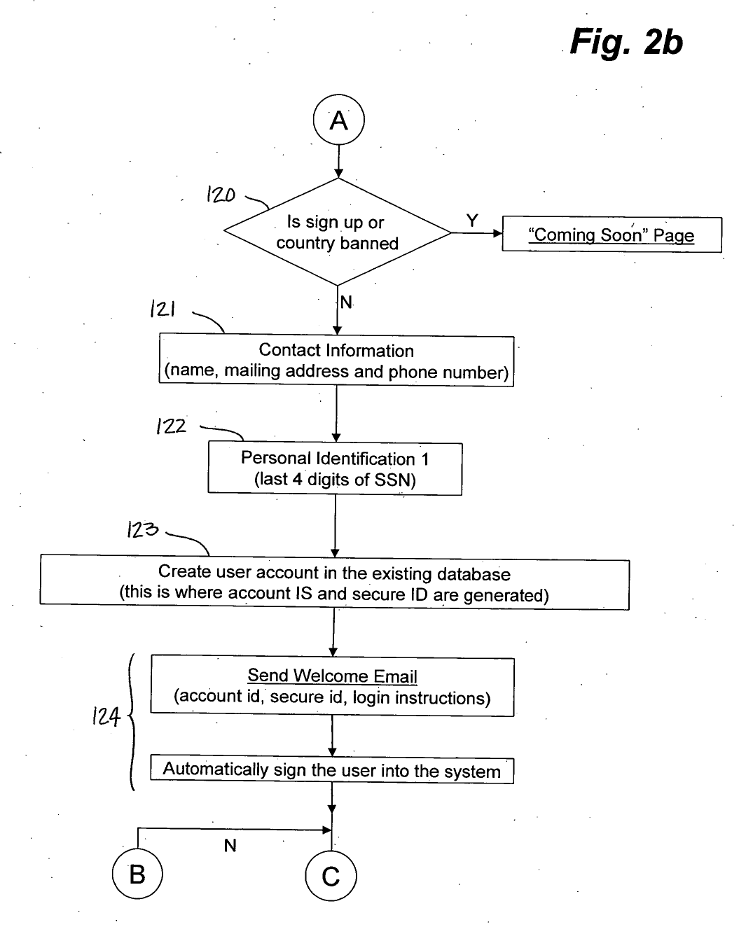

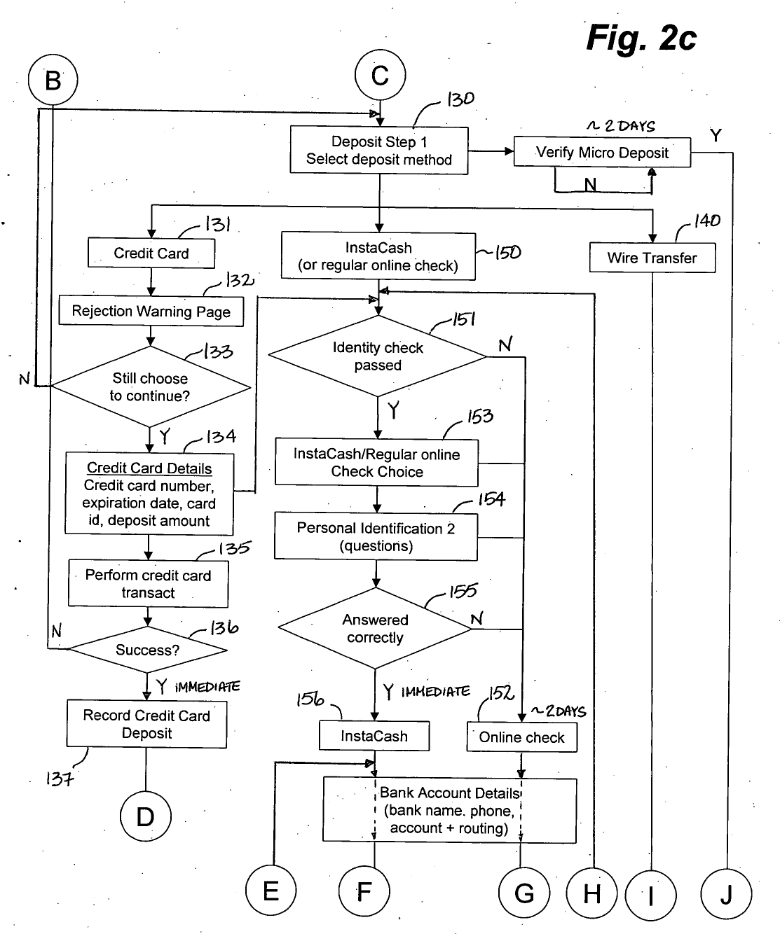

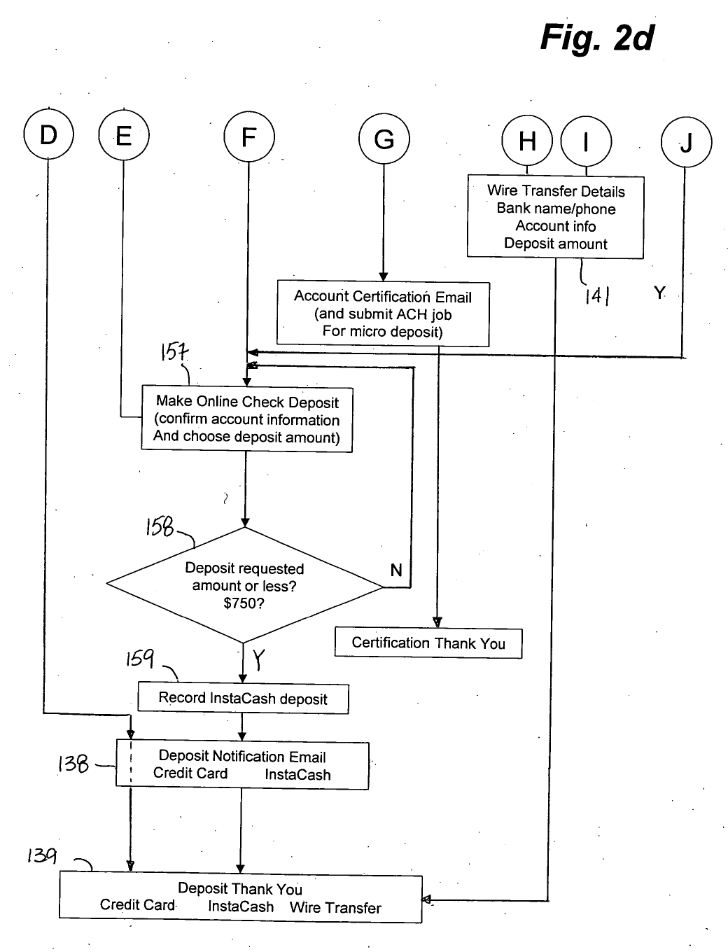

The client 12 enters into communication with the intermediary service 20 through server 20s and at block 41 makes a request for the intermediary service 20 to advance the requested funds to the end merchant 11. At block 42, the server 20s interacts with the client 12 to obtain identification of the source account 14 and assess the client's right to dispense the requested funds from the source account 14. If the assessment is not positive 40n, the server may try again or seek alternate funding options discussed in greater detail in conjunction with FIGS. 2a-2d.

If the assessment is positive 40y then, at block 43, an amount of funds is authorized for advance to the end merchant 11. The assessment may result in limiting the amount of the requested funds to a maximum permitted amount. For example, if the assessment is positive yet minimal, a maximum permitted amount of the funds for transfer may be limited to $750 USD.

The authorization for transfer, at block 43, results in an EFT request 44 to the ACH System 30 for transfer of the permitted amount of funds from the online account 21 to the merchant's account 13. These transferred funds are irrevocably deposited to the merchant account 13.

The end merchant 11 confirms, at block 45, that the transferred funds are received and, at block 46, that the end merchant 11 and client 12 may proceed to conduct their financial transaction.

Only after the transferred funds are irrevocably transferred to the end merchant 11, at block 43, the intermediary service 20 attempts to settle accounts at block 50 through an EFT request 51 to the ACH System 30 for transfer of at least the amount of the transferred funds from the source account 14 to the online account 21. A surcharge fee may be added to the transferred amount included in the EFT request 51. Usually, the EFT request 51 is honoured and the online account 21 is properly reimbursed.

On the other-hand, at block 52, some problems may occur resulting in an early or delayed refusal of recovery of funds from the source account 14. The transferred funds may become returned funds.

At block 53, the financial institution for the source account 14 may dishonour the request for one of many reasons including incorrect identification of the source account, improper authorization for that client 12 or merely insufficient funds (NSF). Such a problem is detected early on and is hopefully solved through contact with the client 12 for corrected details or more rigorous debt-recovery techniques at block 54.

There is not a claw back of the transferred funds from the end merchant 11 and the merchant account 13. The risk is fully that of the intermediary service 20 and not that of the end merchant 11.

Other problems include a charge-back. A charge back may come from a financial institution or credit card issuer such as in the case that the requested funds were through a fraudulent transaction—simply the requesting client 12 was not authorized to disperse funds from the source account 14. It is also known that a client 12, though authorized to draw from the source account 14, may decide to reverse the transaction in breach of their contractual obligations. Financial institutions generally comply with the client's demand.

Accordingly, at block 55, the intermediary service 20 would verify the charge-back details and, at block 56, transfer the permitted amount of the requested funds back to the source account 14 from whence they were originally drawn by initiating an EFT request, at block 57.

Again, there is no reversal of the transferred funds from the end merchant 11 and the merchant account 13. The risk is fully that of the intermediary service 20 and resolution is between the intermediary service and the requesting client 12, not the end merchant 11.

It is an acknowledged and calculated risk that some transactions initiated by clients 12 will fail or result in a charge-back. As suggested, at block 54, when possible, the intermediary service 20 seeks to recover the returned funds. The intermediary service 20 would seek the assistance of the participating end merchant 11 to provide any information that would aid in recovery of the returned funds.

Expedited Advancement of Funds

The indemnification is particularly useful to assist both an end merchant 11 and the client 12. The end merchant 11 seeks to offer the client 12 access to the services immediately rather than risk losing the interest of the client 12. Also, the client seeks to use the services of the end merchant 11 now and would prefer not to wait, for fear of losing an opportunity. As discussed, the problem with such a financial transaction is that on one hand, the end merchant 11 is reluctant to release transferred funds in advance of settlement of an EFT and thus delays gratification of both parties. On the other hand, the client 12 may not have immediate access to funds or the transaction is the first with this end merchant 11 and there is no prior positive balance in the end merchant's account 13 or prior financial history to speak of.

In such a scenario, where funds are to be transferred and applied expeditiously, there is a greater risk to the end merchant 11 where the transferred funds can be or are committed elsewhere before settlement. If the settlement fails then the end merchant 11 loses. Thus, indemnification of an end merchant 11 by the intermediary service 20 becomes more relevant the shorter the turnaround between a request and transfer of the funds.

Thus, the intermediary service 20 exists in part to assess and absorb the risks to the end merchant 11 and offers the client 12 and end merchant 11 expeditious access to funds. The intermediary service 20 enables expeditious payment of funds to the online account 21 for use in making payment to the end merchant 11. The intermediary service 20 is a financial intermediary which manages funds for a plurality of clients 12. As described above, at a client's request and upon the proper validation of the client's rights to funds in the source account 14, funds are substantially contemporaneously and irrevocably transferred from the intermediary services online account 21 to the merchant's account 13 and thus made available for immediate withdrawal by the end merchant 11 or client 12 without need to wait for the ACH System 30 to clear the funds from the client source account 14. Subsequently, the client's source account 14 at a financial institution is debited to the credit of the intermediary service 20 and the online account 21. A client ledger is maintained on behalf of the client 12.

The risk of a returned item to the financial intermediary service 20 is reduced through a novel identity verification system.

In one embodiment of this system for instantaneous, irrevocable and merchant account funding, there are two steps: the signup; and the identity verification.

Briefly, in the first signup step, the client provides basic identification and registers a source bank account 13. This involves entering information about the account (such as an account number, routing/transit number) that the client 12 would prefer as the source account 14 from which to pay funds. In the second step, in order to pledge an advance from the source account 14 to the online account 21 for transfer to the end merchant 11, the client 12 is required to pass an online identity verification process. Once the client 12 passes the identity verification, the intermediary service 20 substantially immediately funds the end merchant's account 13 for subsequent settlement between the source account 14 and the online account 21.

Signup

In greater detail then and turning to FIG. 2a, a prospective client 12 is signed up and a more or less conventional routine is established for confirming email communication and choosing a unique login in name and a password. More particularly, an internet browser interface is contemplated having a home page at block 100. At block 101, in the sign up with the intermediary service 20, the client 12 becomes a member of the service 20 through providing an email address, at block 102, and if the email address exists, evidencing a returning member, at block 103, then returning client 12 is asked to login, at block 104. Note that a variety of signup routines are possible for establishing an online account with a service. Only one embodiment is disclosed herein.

If the email has not been authenticated, at block 105 then, at block 106, an authenticating email is forwarded to the client 12 for confirming their sign up and receipt of same at block 110. If the email is unique and thus a new member, then the client 12 is directed to sign up, at block 107, for review of terms and conditions of the intermediate service and assigning of a login password or other security means, including forwarding of an authentication email through the provided email address at block 108. Notification of the incoming email is provided at block 109. Once authenticated at block 105, the member is invited at block 111 to use the new login and enter the signup for the source account 14 and the like with the usual accommodation for an email password reminder at block 112.

Once the correct login and password have been set up and successfully entered and confirmed at block 113, the intermediary service 20 confirms at block 120 that the client 12 is not otherwise banned geographically or otherwise from participating. Contact information for the client 12 is obtained at block 121 including minimum identification. At block 122, a first level of personal identification verification establishes if the named client 12 is correctly associated with a corresponding social security number (SSN). This can be confirmed with online services such as Verid or Experian services in the United States. To do so, the client 12 is required to provide some verifiable information such as the last 4 digits of their SSN. If successful, the client is added to the member database and appropriate notices are sent to the client.

The client information is stored in a database at block 123 and, at block 124, secure access identification is provided to the client 12 through the aforementioned email address. The usual welcome information is sent to the client and the client is signed in.

The client information may include the details of the source account 14.

Deposit Funding Options

With reference to FIG. 2c, at block 130, the client 12 indicates their desire to make a deposit to the online account 21 which can be made available to participating end merchants 11 of the intermediary service 20. In one embodiment, options for deposit comprise the ACH System 30 dependent approaches dependent upon a cycle of fund transfer and settlement including credit card, wire transfer and account verification through an interactive verification of activity generated in the identified source account 14. In the case of a credit card and a bank wire or wire transfer, the usual verification can be conducted and payment made to the intermediary services and funds credited to the online account. A wire transfer will involve a personal visit to the client's bank; using the bank to authenticate the transfer.

Another deposit approach is to provide a more expeditious approach which is concluded in advance of a full cycle of the ACH System 30. This approach is more risky for the intermediary service 20.

Turning to the credit card approach, at block 131, the client clicks through a warning page at block 132 and if the client chooses to continue at block 133, the conventional credit card details are entered at block 134 and a credit card authorization and deposit is requested at block 135. If successful at block 136, the deposit is recorded at block 137 and at FIG. 2d, notification is provided by email at block 138 at and the funds are available to the online account 21. Typically the funds in the online account 21 or a portion thereof are transferred to the merchant account 13 of the end merchant 11 identified by the client 12 initiating the transfer. Despite a successful credit card authorization and deposit, the intermediary service 20 is still at risk of a charge-back as discussed above.

Turning again to FIG. 2c, at block 140, a wire transfer approach is less risky due to the need for the client 12 to confirm their identify and confirm the necessary funds in the source account 14 with the financial institution for the source account at the time of transfer. At block 141, FIG. 2d, the wire transfer details are confirmed and an advance is made.

Returning to FIG. 2c, for expedited deposit of requested fund to the online account 21, one can implement an instant and virtual cash transfer beginning at block 150. This stream is referred to as Instacash. At block 151, if the initial identify verification or check at block 122 is questionable, then the client 12 is routed to an online check stream in which a full cycle of the ACH System 30 is required to lessen an otherwise apparently higher than acceptable risk transaction. In other words, the Instacash stream is denied.

If the basic verification is successful, then at block 153 the client is given the choice of an online check at block 152 or continuing on the Instacash stream which is still optional due to possible variation in fees applicable with the different streams. Upon selecting the Instacash stream, an identify verification is conducted at block 154.

Verification

Verification at block 154 may vary by geographical region, but typically comprises the client 12 answering 3 or 4 questions about themselves. Contrary to the usual case of merely confirming financial data with a credit bureau, the population of qualifying clients 12 is substantially increased through an emphasis on non-financial information. In contradistinction to credit bureau formats, these questions are general in nature rather than financial.

Where available, the existence of the client's source account 14 is confirmed through ATM Verify. ATM Verify includes status information including open or closed, funds frozen, whether able to receive ACH debit, and positive or negative balances. ATM Verify is not available in all areas.

In greater detail, while credit bureau information is readily available, such as from Experian, many potential clients and users of such online financial intermediaries 20 may not have ever owned a house, paid a mortgage, owned a car, made car payments and thus, while capable of making the financial commitment, would not have the financial credit history to enter the system.

Thus, a non-financial system is provided. Information validation services such as Verid, Inc. compile and enable verification of identify through inquiries regarding the client's travels, pin-pointing of street addresses, color of car, and making selections from a list of known, possible and fictitious associates.

Due to possible inaccuracies in data or its currency, it is not expected that a client would necessarily answer all questions to correspond exactly to the answers on file. Thus, there is a usual threshold set such as 2 out of 3 questions will qualify as a pass, or alternatively for example, 2 out of 3 questions could trigger a second round of an additional number of questions.

If the client's identity does not meet the necessary threshold, they can be routed to more secure, albeit more time-consuming, methods, such as the online check at block 152.

If the client 12 answers the questions correctly, they qualify for Instacash at block 156 and the source account information at block 157 is approved for deposit to the online account 21. At block 158, a finite and maximum amount (e.g. $750) is immediately credited to their online account 21 for settlement and recordation at block 159 from the source account 14 registered earlier. Confirmations at block 138 and 139 are forwarded to the client 12.

Regardless of the amount of the requested transfer, the permitted amount for transfer to the online account 21 is initially limited and reduces the risk to the financial intermediary service 20 by minimizing the loss amount in the event the client's source account 14 ultimately fails the ACH System 30 withdrawal transaction.

Once the transfer is made by the intermediary service to the online account 21, one can immediately transfer the funds to the participating online end merchant 11 registered with the intermediary service 20. Usual in the full cycle of the ACH System 30, and provided as part of the preferred methodology, although the funds are available for transfer immediately, the corresponding settlement withdrawal can take up to 4 days to clear the client's source account 14.

In such cases, the intermediary service 20 obtains a fee, typically as a fixed amount or percentage of the amount transferred. In one embodiment, as the funds being requested for payment to the online account 21 are for a specific amount to meet a specific end merchant payment, the intermediary service withdraws the settlement amount including an additional service fee.

The intermediary service 20 commences the more time-consuming ACH System for recovering the finite amount from the source account 14 while the client immediately obtains the use and benefit of the funds in the online account now for a specified end merchant 11 or for other uses.

Failing Verification

Alternatively, the client 12 may choose at block 153, or be shunted at block 155 upon failing to meet a verification threshold be required, to enter a delayed (several days) account verification process. Similarly this option is available from block 130 wherein a micro-deposit is made to the source account 21 at block 160. The intermediary service can perform one or more ACH System transactions at the source account 21 which can be reviewed and confirmed by the client 12. For instance a small test deposit can be confirmed by the client by making payment of an identical value to the online account 21. Test deposits arrive in American client's accounts in 1-2 working days and 1-5 working days in Canadian client's accounts. Once the amount has been confirmed then the source account 14 and online account 21 are available for use.

At block 152, and related to the Instacash stream, one might still opt for an alternate form of payment called an online check. This is a service which provides an online form resembling a check and which prompts for details from the client's own checks. In some instances, the information is encrypted, forwarded to a service for processing and ACH System 30 performs an EFT, typically within 2 days. Alternatively, the financial intermediary provides the online check, collects the information, and performs either a verification micro deposit to the named source account or submits an ACH request for deposit.

In review, for immediate payment to an online account 21 for funding of an end merchant 11, the client 12 needs to turn to the Instacash option, wherein few or none of the conventional confirmation and time-consuming safeguards are in place.

The intermediary service recognizes that the client 12 is likely (due to the client's selection of the Instacash approach) to make an immediate withdrawal for payment to a participating end merchant 11. Thus, while the intermediary service 20 does forthwith initiate an ACH System EFT request to settle their account by withdrawal from the client's source account 14, it will take several days to clear or it may not clear at all due to either lack of funds or perhaps fraud on behalf of a misrepresenting “client”. Thus, several preferred systems are in place to ensure losses are recovered. A fee is charged to each client for each access to such a deposit option for such convenience. The increased risk, in immediate release of funds to a client 12, is balanced against the increased throughput and the fees collected. A percentage of the value of each Instacash withdrawal can be charged for each access. Further, on the financial intermediary's interactive internet site 100, each time a client selects another optional and delayed deposit or funding means, such as a credit card (for which a the card issuer earns a percentage) or a wire transfer (for which the financial institution generally earns a fee), the client is given the option to try Instacash. Further, once Instacash has been used, options can be provided to avoid future fees by implementing alternate access to payment means. Further, a variety of transaction notifications are provided which emphasize the convenience of Instacash and ways to avoid fees in the future, all of which aid the client in convenience and the intermediary in its financial goals.

The foregoing invention has been described in terms of the preferred embodiment. However, it will be apparent to those skilled in the art that various modifications and variations can be made in the disclosed process without departing from the scope or spirit of the invention. The specification and examples are exemplary only, while the true scope of the invention is defined by the claims.

The embodiments of the invention in which an exclusive property or privilege is being claimed are defined as follows:

1. A method for making an irrevocable advance of funds to an end merchant by a requesting client without waiting for a successful settlement of an electronic fund transfer from the requesting client, the method comprising:
providing an intermediary service having a server system in electronic communication with the client, the end merchant, and an intermediate account;
receiving at the intermediary service an request from the requesting client to transfer an amount of requested funds to the end merchant from a source account;
irrevocably committing at least a permitted amount of the requested amount of the requested funds by initiating an first electronic fund transfer from the intermediate account as transferred funds which are transferred to the end merchant; and thereafter initiating a settlement transaction including submitting a second electronic fund transfer for seeking to recover at least the permitted amount of the requested funds from the source account to the intermediary account.

2. The method of claim 1 wherein prior to irrevocably committing at least a permitted amount of the requested funds, further comprising and substantially contemporaneous with the request, obtaining from the requesting client an assertion of the requesting client's authorization to transfer funds from the source account and limiting the at least a permitted amount of the requested funds to be transferred based on the strength of the client's assertion.

3. The method of claim 1 wherein upon concluding the settlement transaction and wherein the amount of the transferred funds exceeds the amount ultimately received from the source account, further comprising:
settling accounts, up to the at least a permitted amount of the requested funds, only between the source account and the intermediate account so that the end merchant is isolated therefrom and therefore can retain the transferred funds.

4. The method of claim 3 wherein upon settling accounts further comprises receiving notification of insufficient funds for the source account.

5. The method of claim 3 wherein upon settling accounts further comprises receiving a charge-back request for the source account.

6. The method of claim 5 wherein the charge-back request is a result of a fraudulent transaction.

7. The method of claim 3 further comprising releasing the transferred funds to a destination client account of the end merchant from which the requesting client can make periodic access to a whole or a part of the transferred funds expressly for purchasing the goods or services of the end merchant.

8. The method of claim 3 further comprising:
receiving a demand to reverse the transfer of funds which were requested from the source account for return to the source account;
submitting a third electronic fund transfer for least the amount of the requested funds from the intermediary account to the source account and thereby indemnifying the transfer of funds to the end merchant's destination client account.

9. The method of claim 8 wherein before submitting the third electronic fund transfer, further comprising: ascertaining the legitimacy of the demand.

10. The method of claim 7 wherein:
requesting the end merchant to report any residual amount of the requesting client's transferred funds at the time of the demand; and
submitting a fourth electronic fund transfer for the amount of the residual amount from the end merchant's destination client account to the intermediary account.

11. The method of claim 2 wherein the obtaining of an assertion of the requested client's authorization to transfer funds from the source account further comprises challenging the requesting client through one or more questions through the electronic communication.

12. The method of claim 2 wherein the obtaining of an assertion of the requested client's authorization to transfer funds from the source account further comprises:
challenging requesting client through one or more questions; and
comparing answers corresponding to the one or more questions against one or more identity databases, to the client specific answers to establish that a match threshold.

13. The method of claim 3 wherein prior to irrevocably committing at least a permitted amount of the requested funds, further comprising and substantially contemporaneous with the request,
obtaining from the requesting client an assertion of the requesting client's authorization to transfer funds from the source account through one or more questions challenged through the electronic communication and limiting the at least a permitted amount of the requested funds to be transferred based on the strength of the client's assertion.

14. The method of claim 3 wherein prior to irrevocably committing at least a permitted amount of the requested funds, further comprising and substantially contemporaneous with the request:
obtaining from the requesting client an assertion of the requesting client's authorization to transfer funds from the source account by
challenging requesting client through one or more questions; and
comparing answers corresponding to the one or more questions against one or more identity databases, to the client specific answers to establish that a match threshold; and
limiting the at least a permitted amount of the requested funds to be transferred based on the strength of the client's assertion.

15. The method of claim 2 wherein the obtaining of an assertion of the requested client's authorization to transfer funds from the source account further comprises:
providing a question database accessible by the server and having two or more authenticating questions, at least one of which is non-financial, and at least one information server accessible by the authenticating server and having corresponding and account holder specific answers to the non-financial authenticating questions;
posing the authenticating questions to the client and assessing a success or match threshold; and
weighting the match threshold and if greater than approval threshold, then authenticating the requesting client's authorization to the source account;

16. A method for making an irrevocable advance of funds to an end merchant by a requesting client without waiting for a successful settlement of an electronic fund transfer from the requesting client, the method comprising:
providing an intermediary service having a server system in electronic communication with the client, the end merchant, and an intermediate account;
receiving at the intermediary service an request from the requesting client to transfer an amount of requested funds to the end merchant from a source account;
substantially contemporaneous with the request,
obtaining from the requesting client an assertion of the requesting client's authorization to transfer funds from the source account and limiting a permitted amount of the requested funds to be transferred based on the strength of the client's assertion, and
irrevocably committing the permitted amount of the requested funds by initiating an first electronic fund transfer from the intermediate account as transferred funds which are transferred to the end merchant; and thereafter
initiating a settlement transaction including submitting a second electronic fund transfer for seeking to recover at least the permitted amount of the requested funds from the source account to the intermediary account.

17. A system for making an irrevocable advance of funds to an end merchant by a requesting client without waiting for a successful settlement of an electronic fund transfer from the requesting client, the system comprising:
an intermediary service having a server in electronic communication with the client, the end merchant, and an intermediate account;
a client interface for receiving at the intermediary service an request from the requesting client to transfer an amount of requested funds to the end merchant from a source account;
a verification interface for obtaining from the requesting client an assertion of the requesting client's authorization to transfer funds from the source account and limiting a permitted amount of the requested funds to be transferred based on the strength of the client's assertion;
a first automated clearinghouse request means for committing transfer of the permitted amount of the requested funds from the intermediate account as transferred funds which are transferred to the end merchant, the transferred funds being irrevocable to the end merchant; and
a second automated clearinghouse request means for initiating a settlement transaction including transfer of at least the permitted amount of the requested funds from the source account to the intermediary account.

18. The system of claim 17 wherein a charge-back is received from the source account, further comprising:
a third automated clearinghouse request means for initiating a transfer for least the amount of the permitted funds from the intermediary account to the source account and thereby indemnifying the transfer of funds to the end merchant's destination client account.

19. The system of claim 17 wherein the verification interface, further comprises:
a question database accessible by the server and having two or more authenticating questions, at least one of which is non-financial, and at least one information server accessible by the authenticating server and having corresponding and account holder specific answers to the non-financial authenticating questions; and wherein
the client interface poses the authenticating questions to the client and assesses a success or match threshold; and the server weights the match threshold and if greater than approval threshold, then authenticating the requesting client's authorization to the source account;
